(19) United States
(12) Patent Application Publication
(10) Pub. No.: US 2026/0090554 A1
(43) Pub. Date: Apr. 2, 2026

(54) METHOD OF PRODUCING SMOKED MEAT WITH REDUCED HARMFUL COMPONENTS

(71) Applicant: Wa-ryong Food Co., Ltd., Daegu (KR)

(72) Inventor: Kyeong Do KIM, Gyeongsan-si (KR)

(21) Appl. No.: 18/959,727

(22) Filed: Nov. 26, 2024

(30) Foreign Application Priority Data
Sep. 27, 2024 (KR) 10-2024-0131238

(51) Int. Cl. A23B 4/052; A23L 5/10

(52) U.S. Cl. CPC A23B 4/0523; A23L 5/17

(57) ABSTRACT

A method of producing smoked meat using a tunnel-type automatic grilling device is provided, wherein the grilling device includes a frame, a transporting unit formed in an open area of the frame, a smoking unit formed at one side of the frame, a plurality of burner units formed below the frame at predetermined intervals, the radiant heat being radiated from an elvan stone heated by burning of oak firewood inserted into the burner unit, a plurality of heating units formed at predetermined intervals at a location corresponding to the burner unit above the frame, a temperature of the heating unit ranges from 150 to 200° C., and a retention time for which the meat transported by the transporting unit retains between the burner unit and the heating unit ranges from 1 to 5 minutes.

### CROSS-REFERENCE TO RELATED APPLICATION

This application claims priority to and the benefit of Korean Patent Application No. 2024-0131238, filed on Sep. 27, 2024, the disclosure of which is incorporated herein by reference in its entirety.

### BACKGROUND

### 1. Field of the Invention

The present invention relates to a method of producing smoked meat with reduced harmful components, and more specifically, to a method of producing smoked meat with reduced harmful components using a tunnel-type automatic grilling device.

### 2. Discussion of Related Art

In general, methods of grilling meat include a method of directly exposing meat to charcoal or wood fire and grilling the meat by radiant heat, a method of placing meat on a grilling plate heated by a heat source and grilling the meat by conductive heat, and a method of grilling meat by convective heat transfer using hot air.

Among these, the method of directly exposing meat to charcoal or wood fire is preferred by many people because a burning temperature of charcoal or firewood is high to shorten the grilling time and the smoke generated when charcoal or firewood is burned permeates the meat to enhance its flavor.

However, when by-products such as meat juice or oil falls from meat, there are problems that a lot of smoke is generated due to a reaction between the by-product and the heat source, and in this process, harmful substances such as polycyclic aromatic hydrocarbons (PAHs) are also generated, thereby threatening our health, and due to the uneven distribution of the heat source and structural problems, partial over-burning or non-burning occurs, thereby reducing the taste of the meat.

In addition, since it takes a long time to burn charcoal or firewood and it is difficult to control the temperature, there are cases in which the meat burns easily, and there is a problem that the oil generated from the meat falls on the firewood to generate soot.

In particular, when grilling meat using charcoal or firewood, workers have to continuously check the degree of cooking of the meat, and thus when the meat is delivered to a restaurant or processing company through the first grilling at the factory, there is a problem that the production volume is small and the quality is not consistent.

To solve these problems, the applicant proposed a tunnel-type automatic grilling device through Korean Patent Registration No. 2095872. The device automatically transports meat when receiving the meat and performs smoking and grilling, so has a high production volume and consistent quality and is designed so that the flame does not directly touch the meat and soot or smoke is not generated due to the oil discharged from the meat, thereby suppressing the generation of harmful substances such as benzopyrene (a polycyclic aromatic hydrogen (PAH)) to some extent.

However, as a result of additional research by the applicant, it was found that even when the device was used, some harmful substances could be included in the meat due to benzopyrene contained in the oak smoke, and to suppress its content, it was necessary to appropriately manage the process conditions, leading to the completion of the present invention.

### SUMMARY OF THE INVENTION

The present invention is directed to providing a method of producing smoked meat with reduced harmful components.

According to one aspect of the present invention, a method of producing smoked meat using a tunnel-type automatic grilling device is provided, wherein the tunnel-type automatic grilling device includes a frame formed so that various members are mounted thereon and having an open center, a transporting unit formed in an open area of the frame and configured to transport meat from one side to the other side of the frame by external power, a smoking unit formed at one side of the frame and configured to supply smoke to the meat transported by the transporting unit to improve flavor, a plurality of burner units formed below the frame at predetermined intervals and configured to apply radiant heat to a lower portion of the meat transported by the transporting unit, the radiant heat being radiated from an elvan stone heated by burning of oak firewood inserted into the burner unit, a plurality of heating units formed at predetermined intervals at a location corresponding to the burner unit above the frame and configured to apply heat to an upper portion of the meat transported by the transporting unit, and exhaust units formed between the smoking unit and the heating unit and between the plurality of heating units and configured to suction smoke generated by burning the oak firewood and then supplying the suctioned smoke to the smoking unit, a temperature of the heating unit ranges from 150 to 200° C., and a retention time for which the meat transported by the transporting unit retains between the burner unit and the heating unit ranges from 10 to 60 minutes.

The oak firewood may be burned inside a burning chamber, and an internal temperature of the burning chamber may range from 250 to 500° C.

A concentration of carbon oxide inside the burning chamber may range from 25 to 60%.

The smoking unit may include a smoking chamber formed above the frame and having one side formed with an inlet hole to which oak smoke is supplied and the other side formed with an outlet hole to which the oak smoke is discharged to smoke the meat so that oak scent is applied to the meat transported by the transporting unit, and a sealed chamber formed below the frame to prevent the oak smoke from leaking downward from the frame or the introduction of outside air.

A concentration of the oak smoke inside the smoking chamber may range from 50 to 300 ppm.

The exhaust unit may further include an introduction prevention wing for preventing outside air from being introduced from a gap between the exhaust unit and the smoking unit or the heating unit.

The burner unit may include a burning chamber of which upper side is open and the inside is empty, a burning device formed at an inner central portion of the burning chamber to ignite a fire using gas supplied from the outside, a firewood box formed on the burning device and formed so that firewood is inserted and placed inside the burning chamber, a stand which is formed on the firewood box and on which an elvan stone that prevents a flame of the firewood from coming into direct contact with the meat is placed, and a collection box formed below the burning device and configured to collect ash generated by the burning of the firewood.

### BRIEF DESCRIPTION OF THE DRAWINGS

FIG. 1 is a perspective view showing a state in which a tunnel-type automatic grilling device is operated according to the present invention.

FIG. 2 is a perspective view showing a state in which the interior of the tunnel-type automatic grilling device is opened for maintenance according to the present invention.

FIG. 3 is a perspective view showing a state in which a structure of a transporting unit is separated from the tunnel-type automatic grilling device according to the present invention.

FIG. 4 is a perspective view showing a structure of the tunnel-type automatic grilling device according to the present invention in detail.

FIG. 5 is a cross-sectional view showing an internal structure of the tunnel-type automatic grilling device according to the present invention.

FIG. 6 is an enlarged cross-section view showing an internal structure of a burner unit of the tunnel-type automatic grilling device according to the present invention in detail.

FIG. 7 is an enlarged cross-section view showing an oil collector of the tunnel-type automatic grilling device according to the present invention.

### DETAILED DESCRIPTION OF EXEMPLARY EMBODIMENTS

Advantages and features of the present invention and methods for achieving them will become clear with reference to embodiments described below in detail together with the accompanying drawings.

However, the present invention is not limited to the embodiments disclosed below but can be implemented in various different forms, these embodiments are merely provided to make the disclosure of the present invention complete and fully inform those skilled in the art to which the present invention pertains of the scope of the present invention, and the present invention is only defined by the scope of the appended claims.

Therefore, in some embodiments, well-known process operations, well-known structures, and well-known technologies are not specifically described to avoid ambiguity in the interpretation of the present invention.

Terms used in the present specification are intended to describe the embodiments and are not intended to limit the present invention. In the present specification, the singular form also includes the plural form unless specifically stated in the phrase.

Throughout the present specification, when a first component is described as being “connected to” a second component, it includes not only a case in which the first component is “directly connected” to the second component, but also a case in which the first component is “indirectly connected” to the second component with a third component interposed therebetween. In addition, when a first member is described as being located “on,” “above,” “on an upper end of,” “under,” “below,” or “on a lower end of” a second member, this includes both a case in which the first member comes into contact with the second member and a case in which a third member is present between the two members.

Throughout the present specification, when a certain portion is described as “including” a certain element, it means that the certain portion may further include other elements rather than precluding other elements unless specifically stated to the contrary.

The embodiments described in the present specification will be described with reference to cross-sectional and/or perspective views, which are ideal exemplary views of the present invention. In addition, the same reference numeral denotes to the same component throughout the specification. In this case, detailed descriptions of well-known functions and components that may obscure the gist of the present invention are omitted. In addition, components in each drawing shown in the present invention may be shown as being somewhat enlarged or reduced for convenience of description.

Hereinafter, a tunnel-type automatic grilling device suitable for implementing a method of producing smoked meat according to one aspect of the present invention will be described in detail.

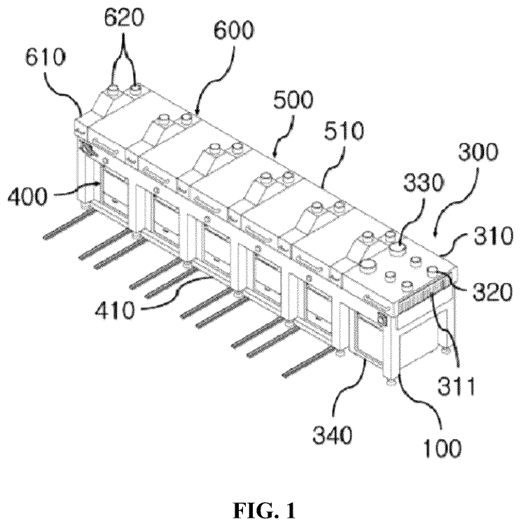

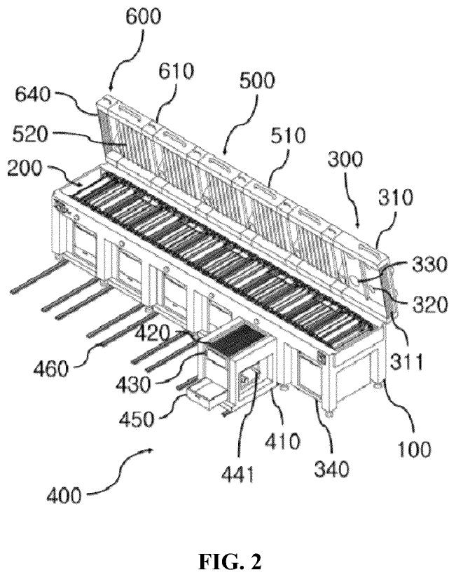

FIG. 1 is a perspective view showing a state in which a tunnel-type automatic grilling device is operated according to the present invention, and FIG. 2 is a perspective view showing a state in which the interior of the tunnel-type automatic grilling device is opened for maintenance according to the present invention.

As shown in FIGS. 1 and 2, the tunnel-type automatic grilling device according to the present invention includes a frame 100 formed so that various parts may be mounted thereon and having an open center, a transporting unit 200 formed in an open area of the frame 100 and configured to transport meat from one side to the other side of the frame 100 by external power, a smoking unit 300 formed at one side of the frame 100 and configured to supply smoke to the meat transported by the transporting unit 200 to enhance flavor, a burner unit 400 formed below the frame 100 and configured to apply direct or radiant heat to a lower portion of the meat transported by the transporting unit 200, a heating unit 500 formed above the frame 100 on which the burner unit 400 is formed and configured to apply heat to an upper portion of the meat, and an exhaust unit 600 formed on a side surface of the smoking unit 300 or the heating unit 500 to discharge smoke to the outside.

The frame 100 has the open center and has a plurality of legs for separating an upper surface of the frame 100 from a floor surface, which are formed to be spaced at regular intervals from each other on lower portions of front and rear surfaces thereof.

Since the transporting unit 200 is formed in the open area of the frame 100, meat placed on a hot plate or grill may be transported from one side to the other side of the frame 100 by the transporting unit 200.

The smoking unit 300 is formed at one side of the frame 100, and smoke generated when oak is burned is applied to the meat to enhance flavor.

In this case, the smoking unit 300 includes a smoking chamber 310 formed on the frame 100 to supply and discharge oak smoke, and a sealed chamber 340 formed at the lower portion of the frame 100 to prevent oak smoke from leaking downward from the frame 100 or the introduction of outside air.

The smoking chamber 310 has a ‘c’-shaped cross section in close contact with front and rear surfaces of the frame 100 and has a separated center so that meat transported by the transporting unit 200 does not get caught, and the meat may be inserted into the frame 100 through an inlet 311 formed at one side of the smoking chamber 310.

In this case, the inlet 311 preferably has a plurality of membranes formed to prevent the introduction of outside air, thereby preventing the introduction of foreign substances or dust included in the outside air.

A plurality of inlet holes 320 are formed at one side of an upper portion of the smoking chamber 310 so that oak smoke may be introduced, and a plurality of outlet holes 330 for discharging the oak smoke to the outside are formed at the other side.

Smoke generated when oak is burned flows into the smoking chamber 310 through the inlet holes 320, and when meat is transported by the transporting unit 200, the oak smoke comes into contact with the meat to apply the scent of oak to the meat.

In addition, the oak smoke is not discharged to the inlet 311 through the outlet holes 330 formed at the other side of the smoking chamber 310 but may move in a direction in which the outlet holes 330 are formed to control the amount of oak smoke remaining inside the smoking chamber 310 through the outlet holes 330.

The sealed chamber 340 is located at the lower portion of the frame 100 to prevent outside air from being introduced from the outside of the frame 100, and when meat juice or oil falls while smoking, the meat juice or oil is collected so that workers may recover and discard the collected meat juice or oil.

The burner unit 400 is formed at the lower portion of the frame 100 and used to burn oak wood to apply heat to the lower portion of the meat moving to the other side of the frame 100 through the transporting unit 200, and a plurality of burner units 400 are formed at regular intervals at the lower portion of the frame 100.

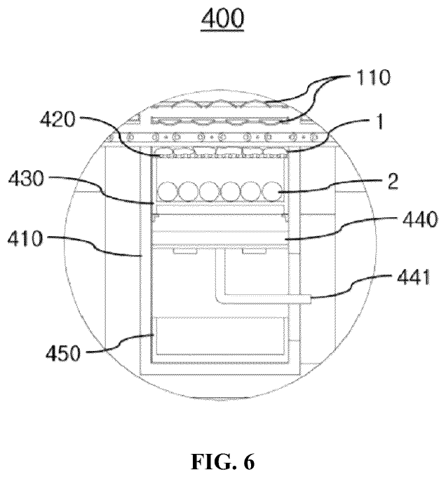

In this case, the burner unit 400 includes a burning chamber 410 of which upper side is open and the inside is empty, a burning device 440 (see FIG. 6) formed at an inner central portion of the burning chamber 410 to ignite a fire with gas supplied from the outside, a firewood box 430 formed on the burning device 440 and formed so that firewood may be inserted and placed inside the burning chamber 410, a stand 420 formed on the firewood box 430 to place an elvan stone to prevent the flame of the firewood from coming into direct contact with the meat, and a collection box 450 formed under the burning device 440 to collect ash generated when the firewood is burned.

The inside of the burning chamber 410 is empty and an upper side thereof is open, the burning device 440 of FIG. 6 is formed at the inner central portion thereof, and a flame is formed using the gas supplied from a gas pipe 441 to burn the oak wood located in the firewood box 430.

In this case, the stand 420 for placing the elvan stone is formed at the upper portion of the burning chamber 410, the upper portion of the burning chamber 410 is filled with the elvan stone through the stand 420, and a heat source generated when the oak wood is burned is transferred to the elvan stone.

The heat source generated through such a process generates and transfers radiant heat through the elvan stone to a lower surface of the meat, and the meat does not come into direct contact with the flame generated by the oak wood, so no soot is generated.

In addition, since far-infrared rays are emitted by the elvan stone, heat may penetrate deeper into the meat, thereby increasing the speed at which the meat is cooked.

Inside the burning chamber 410, a separate air introduction pipe (not shown) is preferably formed to allow outside air to be introduced or a switch (not shown) is formed to block the amount of introduced air, and a temperature at which the oak is burned may be controlled through the air introduction pipe or the switch.

In addition, the collection box 450 may be formed at the lower portion of the burning chamber 410 to collect the ash generated when the oak is burned, and the collection box 450 slides to a front surface of the burning chamber 410 to remove the collected ash.

The firewood box 430 is located at a front upper portion of the burning chamber 410 and may be opened or closed by rotating laterally to supply firewood inside the firewood box 430, and a plurality of rods are formed inside the firewood box 430 so that oak may be placed thereon.

In addition, the firewood box 430 preferably has a transparent window formed on a front surface thereof so that a state in which oak is burned may be checked, and the worker may check the amount of burned oak through the transparent window.

In addition, the burner unit 400 further includes a guide rail 460 formed at a lower portion of the burner unit 400 and protruding toward the front surface of the frame 100, and the burner unit 400 may slide along the guide rail 460 toward the front surface of the frame 100 to enable maintenance.

For maintenance of the burner unit 400, the guide rail 460 may be formed at the lower portion of the burning chamber 410, and the burning chamber 410 may protrude toward the front surface of the frame 100 along the guide rail 460.

When the burning chamber 410 protrudes outward from the frame 100, the worker may check states of the burning device 440 and the elvan stone of FIG. 6 that are formed inside the burning chamber 410 and conveniently clean the device when not in use.

A plurality of heating units 500 are formed above the frame 100 in which the burner unit 400 is formed and used to heat the upper surface of the meat being transported using a heat source generated by electricity.

In this case, the heating unit 500 is formed with a heating chamber 510 having a ‘⊂’-shaped cross section so that the meat may pass therethrough, and a plurality of heaters 520 are formed in the open area of the heating chamber 510 to electrically control a temperature.

The exhaust unit 600 is used to discharge steam and smoke generated while the meat is cooked to the outside, and a plurality of exhaust units are formed at regular intervals above the frame 100, and more specifically, are located at each of the other side of the heating unit 500 and the other side of the smoking unit.

In this case, the exhaust unit 600 is formed so that the meat may pass through the open area through the exhaust chamber 610 having a ‘⊂’-shaped cross section, and exhaust holes 620 may be formed at an upper portion thereof so that the smoke inside the frame 100 may be discharged by an exhaust device (not shown) formed outside.

In addition, an outlet 640 is formed in the exhaust chamber 610 located at the other side of the frame 100, and a plurality of membranes are preferably formed at the outlet 640 to prevent the introduction of outside air to prevent the introduction of foreign substances or dust included in the outside air.

In addition, the exhaust unit 600 supplies smoke generated when firewood accommodated inside the burner unit 400 is burned to the smoking unit 300.

The smoking unit 300 needs to supply smoke generated by burning oak to apply oak flavor to meat, and the exhaust unit 600 may suction air generated when oak is burned in the burner unit 400 and supply the suctioned air to the smoking unit 300 without burning oak separately in the smoking unit 300.

That is, the exhaust unit 600 formed near the burner unit 400 suctions the smoke generated when oak is burned in the burner unit 400 and supplies the suctioned smoke to the inlet hole 320 formed in the smoking unit 300 without discharging the suctioned smoke to the outside, and the oak smoke supplied to the inlet hole 320 may be discharged to the outside through the outlet hole 330.

More preferably, it is preferable to suction only the smoke generated from the burner unit 400 located between one side and the other side of the frame 100 among the burner units 400 and then supply the suctioned smoke, thereby preventing the oak scent from being diluted by outside air.

In addition, the smoking unit 300, the heating unit 500, and the burner unit 400 are hinge-coupled to the rear surface of the frame 100 to rotate from the frame 100.

The smoking unit 300, the heating unit 500, and the burner unit 400 are all formed on the upper surface of the frame 100 and are rotatably hinge-coupled to an upper rear surface of the frame 100 so that the worker may rotate the smoking unit 300, the heating unit 500, and the burner unit 400 upward to check the inside of the frame 100.

Therefore, the states of various devices mounted inside the frame 100 may be checked or maintained and repaired, and inner surfaces of the smoking unit 300, the heating unit 500, and the burner unit 400 may be maintained and repaired.

In addition, a handle is preferably formed on front surfaces of the smoking unit 300, the heating unit 500, and the burner unit 400 to more easily rotate the smoking unit 300, the heating unit 500, and the burner unit 400.

In addition, a temperature sensor (not shown) for measuring an internal temperature is formed on each of the burner unit 400 and the heating unit 500, and the transporting unit 200 controls the speed of moving the meat according to a temperature measured by the temperature sensor.

The temperature sensor (not shown) for measuring the internal temperature is formed inside each of the burner unit 400 and the heating unit 500 to adjust a temperature of the heater 520 of the heating unit 500 according to the temperature measured by the temperature sensor or adjust a flow rate of air supplied to the inside of the burner unit 400 to control the temperature.

In this case, the transporting unit 200 is formed so that the transporting speed is controlled according to a change in temperature of the burner unit 400 and the heating unit 500.

That is, when the temperatures of the burner unit 400 and the heating unit 500 are higher than a set temperature, the transporting speed may be increased so that the meat does not burn, and when the temperatures of the burner unit 400 and the heating unit 500 are lower than the set temperature, the transporting speed may be decreased so that the meat may be sufficiently cooked.

Therefore, the state of cooking of the meat may be adjusted according to the temperature, and the degree of cooking of the discharged meat may be consistently maintained.

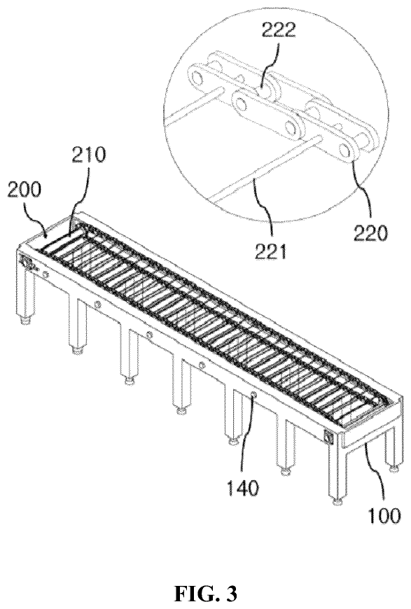

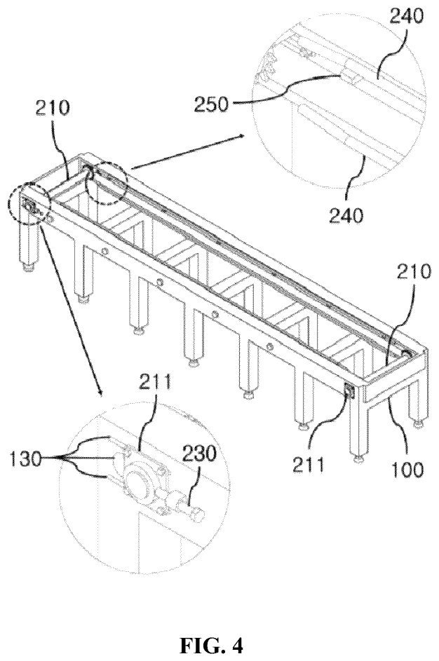

FIG. 3 is a perspective view showing a state in which a structure of a transporting unit is separated of the tunnel-type automatic grilling device according to the present invention, and FIG. 4 is a perspective view showing a structure of the tunnel-type automatic grilling device according to the present invention in detail.

As shown in FIGS. 3 and 4, the transporting unit 200 of the tunnel-type automatic grilling device according to the present invention includes a drive shaft 210 formed at each of the open one side and the other side of the frame 100 and rotating by receiving power from the outside, a transporting chain 220 connected to each of front and rear surfaces of the drive shaft 210 to move the one side and the other side of the frame 100, a support 221 located between the transporting chains 220 to move a grill plate on which meat is placed, and a guide rod 240 formed on each of open front and rear surfaces of the frame 100, supporting lower portions of the transporting chains 220, and moving the grill plate in a set direction.

The transporting chain 220 is formed with a connecting roller 222 formed so that two surfaces are spaced apart from each other to freely rotate at the center, and the connecting roller 222 comes into close contact with an outer surface of the guide rod 240 to reduce a frictional force when the transporting chain 220 is moved by the drive shaft 210.

In addition, since the transporting chain 220 is formed on each of the front and rear surfaces of the frame 100 and the two transporting chains 220 are connected through the support 221, when the grill plate with meat thereon is placed on the support 221, the transporting chain 220 is moved by the drive shaft 210, and the support 221 is moved so that the meat may move to the other side of the frame 100 along the transporting chain 220.

In this case, to prevent the sagging of the support 221 or the sagging of the transporting chain 220 due to the weight generated by the grill plate and meat, the transporting chain 220 is moved along the cylindrical guide rod 240 fixed to the frame 100, and the guide rod 240 is supported by a plurality of support members 250 protruding outward from the open front and rear surface of the frame 100.

The drive shaft 210 has a gear formed on each of the front and rear surfaces to move the chain, and when the drive shaft 210 rotates, the gears are engaged with the transporting chain 220 so that the transporting chain 220 rotates from one side to the other side and from the other side to one side of the frame 100.

In this case, the connecting roller 222 formed on the transporting chain 220 may freely rotate along the guide rod 240 to move smoothly without noise or frictional resistance.

In addition, the transporting unit 200 is formed so that a plurality of transporting chains 220 are transported by the drive shaft 210 formed at the one side and the other side of the frame 100, and the drive shaft 210 is transported horizontally to adjust the tension of the transporting chain 220 when the transporting chain 220 expands by heat or contracts by cooling.

The drive shaft 210 is formed to protrude to the front and rear surfaces of the frame 100 and then be fixed to the outer surface of the frame 100 by a fixture 211, and the drive shaft 210 formed at the other side of the frame 100 is formed so that the transporting chain 220 may adjust the tension of the transporting chain 220 according to the contraction or expansion occurring depending on the temperature.

To this end, a plurality of location adjustment grooves 130 formed so that the fixture 211 and the drive shaft 210 may move horizontally are formed in each of front and rear surfaces of the other side of the frame 100, and the drive shaft 210 and the fixture 211 may move horizontally through the location adjustment groove 130.

In this case, even when the drive shaft 210 moves horizontally, the drive shaft 210 may be restored to its original location by the tension of the chain, so a pressing member 230 for pressing the fixture 211 of the drive shaft 210 is formed on each of the front and rear surfaces of the frame 100.

The pressing member 230 may be screw-coupled to the frame 100 and may move in a horizontal direction of the frame 100 according to a rotational direction, and the tension of the chain may be adjusted by pressing the fixture 211 horizontally to prevent the drive shaft 210 from being restored to its original location by the tension of the chain.

In addition, since a temperature measuring device 140 capable of visually checking the temperature of the burner unit 400 may be formed on the front surface of the frame 100 into which the burner unit 400 of FIG. 2 is inserted, the worker may visually check the internal temperature of the burner unit 400.

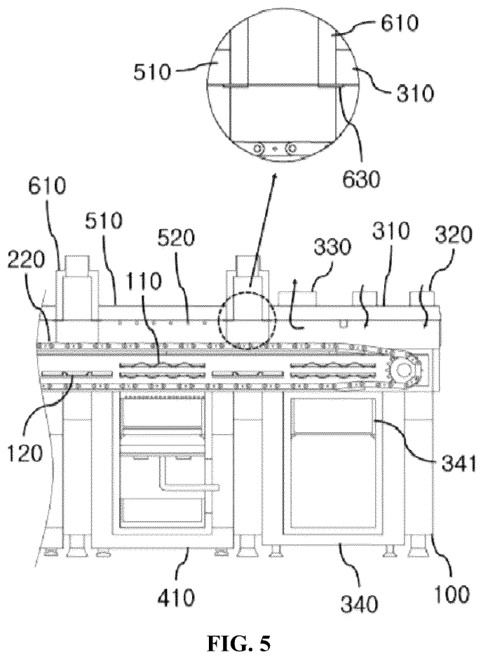

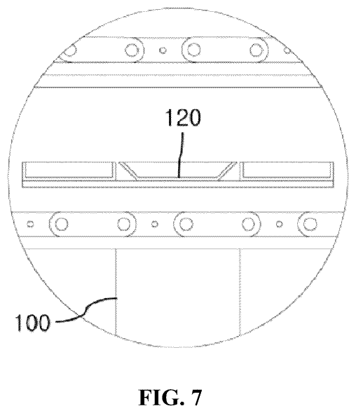

FIG. 5 is a cross-sectional view showing an internal structure of the tunnel-type automatic grilling device according to the present invention, FIG. 6 is an enlarged cross-section view showing an internal structure of a burner unit 400 of the tunnel-type automatic grilling device according to the present invention in detail, and FIG. 7 is an enlarged cross-section view showing an oil collector 120 of the tunnel-type automatic grilling device according to the present invention.

As shown in FIGS. 5 to 7, the exhaust unit 600 of the tunnel-type automatic grilling device according to the present invention further includes an introduction prevention wing 630 for preventing outside air from being introduced through a gap between the exhaust unit 600 and the smoking unit 300 or the heating unit 500.

Since the exhaust chamber 610 formed in the exhaust unit 600 is located between the smoking chamber 310 or the heating chamber 510 and the exhaust chamber 610, the smoking chamber 310, and the heating chamber 510 are each formed independently, there is a problem that when the air inside the frame 100 is discharged to the outside through the exhaust chamber 610, outside air may be introduced through the gap formed between the parts, thereby lowering the internal temperature of the frame 100.

To solve this problem, an elastic introduction prevention wing 630 is formed at both sides of a lower surface of the exhaust chamber 610, and the introduction prevention wings 630 fill the gap between adjacent smoking chambers 310 or heating chambers 510, thereby preventing the introduction of outside air while allowing the smoke inside the frame 100 to be suctioned and discharged to the outside.

In addition, since the introduction prevention wing 630 has elasticity, it is possible to prevent the introduction prevention wing 630 from being damaged when the heating unit 500, the smoking unit 300, and the exhaust unit 600 rotate.

In addition, the smoking unit 300 further includes a sealed chamber 340 formed at the lower portion of the frame 100 and preventing outside air from being introduced from the lower portion of the frame 100 or smoke from leaking to the outside, and the sealed chamber 340 is formed to collect oil discharged from meat.

The frame 100 further includes an oil pan 110 formed at the open area of the frame 100 and preventing the oil discharged from meat from flowing into a burner chamber.

The smoking unit 300 includes the smoking chamber 310 formed on the frame 100 and the sealed chamber 340 formed at the lower portion of the frame 100, and the sealed chamber 340 is formed to seal the lower portion of the frame 100 in which the smoking chamber 310 is formed to prevent air from being introduced from the lower portion of the frame 100 and to collect meat juice or oil generated from the meat during smoking.

In this case, the collected oil is stored in a recovery box 341 formed at an upper end of the sealed chamber 340, and the worker may separate the recovery box 341 from the sealed chamber to remove the oil stored in the recovery box 341.

In addition, an oil pan 110 is formed between the burner unit 400 and the heating unit 500 to receive the meat juice and oil discharged from the meat because the temperature is relatively high so that meat may be cooked.

The oil pan 110 is located at the upper portion of the burner unit 400 and formed to cross the open area of the frame 100.

In this case, the oil pan 110 is formed in multiple stages and has an upper end formed in a convex shape so that oil may fall down and a lower end formed in a concave shape to collect the meat juice and oil that fall from the upper end.

That is, when meat juice or oil falls, the meat juice or oil may fall on the convex upper end and may be collected on the concave lower end, and the collected oil may be discharged by being evaporated by the hot heat generated from the burner unit 400 without being removed separately.

Therefore, the worker may remove only the solid matter remaining in the oil pan 110 after the device is stopped, making management convenient, separate the oil pan 110 from the frame 100, and separately wash the oil pan 110.

In addition, the oil collector 120 is formed in the open area of the frame 100 at a location at which the exhaust unit 600 is formed, and the oil collector 120 is formed to collect the meat juice or oil that falls from the meat or oil that falls as the vapor discharged by being evaporated cools.

In this case, the oil collector may preferably discharge oil to the outside through a hole and is preferably formed to be separated from the frame 100 and washed.

As described above, according to the tunnel-type automatic grilling device of the present invention, when meat is put in, the meat may automatically move to automatically perform smoking and grilling and may be discharged, thereby increasing a production volume, and a transporting speed of the meat may be actively controlled according to the temperature of the heat source to control the cooking time of the meat, thereby preventing a flame from being directly exposed to the meat, preventing soot or smoke from being generated by the oil discharged from the meat, and since the internal devices may be easily checked, there is an effect of easy maintenance.

Hereinafter, according to one aspect of the present invention, in a method of producing smoked meat, optimal process conditions for suppressing the content of harmful substances included in the smoked meat will be described in detail.

### (1) Temperature of Heating Unit

The temperature of the heating unit preferably ranges from 150 to 200° C., more preferably, from 160 to 190° C., and even more preferably, from 165 to 180° C.

The oak smoke generated from the burner unit passes through the transporting unit and comes into contact with the heating unit located above the transporting unit before moving to the smoking unit through the exhaust unit, and at this time, the oak smoke is subjected to secondary heating. The oak smoke is modified during such secondary heating, and particularly, when the temperature of the heating unit is 150° C. or higher, the modification effect is clearly confirmed. The mechanism of such modification of the oak smoke is not clear, but it is presumed that it is because the hydrocarbons of a polymer are decomposed by the secondary heating.

On the other hand, the higher the temperature of the heating unit, the more advantageous it may be for the modification of oak smoke, but when the temperature is excessive, a portion of the meat may be carbonized by being overcooked, and as a result, some harmful substances may be included in the smoked meat. In addition, the surface of the meat may shrink, thereby deteriorating texture. Considering this, the upper limit of the temperature is limited to 200° C.

### (2) Retention Time of Meat

The retention time of the meat transported by the transporting unit between the burner unit and the heating unit preferably ranges from 10 to 60 minutes, more preferably, from 20 to 45 minutes, and even more preferably, from 25 to 35 minutes.

Since the temperature of the heating unit is set somewhat high for secondary heating of the oak smoke, it is necessary to appropriately manage the retention time of the meat. When the retention time of the meat exceeds 60 minutes, a portion of the meat may be carbonized by being overcooked, and as a result, some harmful substances may be included in the smoked meat. In addition, the surface of the meat may shrink, thereby deteriorating texture. In contrast, when the retention time of the meat is too short, there is a concern that the meat may not be sufficiently cooked. Considering this, the lower limit of the retention time is limited to 10 minutes.

The retention time of the meat may be controlled by adjusting the transporting speed of the meat by the transporting unit.

### (3) Internal Temperature of Burning Chamber

The internal temperature of the burning chamber may range from 250 to 500° C., preferably, from 300 to 450° C., and more preferably, from 350 to 400° C.

The internal temperature of the burning chamber affects the amount of generated smoke and the quality of smoke. The higher the internal temperature of the burning chamber, the more the amount of generated smoke increases and the richer the variation of the scent. To secure a sufficient amount of smoke and obtain high-quality smoke, it is preferable to control the internal temperature of the burning chamber to 250° C. or higher. However, since the generation of benzopyrene is accelerated when the temperature is too high, the upper limit is limited to 500° C.

The internal temperature of the burning chamber may be controlled by adjusting a flow rate of air supplied into the burner unit.

### (4) Concentration of Carbon Dioxide Inside Burning Chamber

The concentration of carbon dioxide inside the burning chamber may range from 25 to 60%, preferably, from 30 to 55%, and more preferably, from 35 to 50%.

The concentration of carbon dioxide inside the burning chamber increases immediately after the pyrolysis of oak starts, reaches a maximum of about 75%, and then gradually decreases as pyrolysis progresses. The concentration of carbon dioxide inside the burning chamber affects the quality of smoke, and it is preferable to control the concentration of carbon dioxide inside the burning chamber to 60% or less to obtain high-quality smoke. Meanwhile, when the concentration of carbon dioxide inside the burning chamber is too low, there is a concern that the content of benzopyrene in the oak smoke may be excessive. Considering this, the lower limit of the concentration of carbon dioxide inside the burning chamber is limited to 25%.

The concentration of carbon dioxide inside the burning chamber may be measured by an exhaust gas analyzer and controlled by adjusting the flow rate of air supplied into the burner unit or replacing excessively pyrolyzed oak with new oak.

### (5) Concentration of Oak Smoke Inside Smoking Chamber

The concentration of oak inside the smoking chamber may range from 50 to 300 ppm, preferably, from 80 to 250 ppm, and more preferably, from 100 to 200 ppm.

The higher the concentration of oak smoke inside the smoking chamber, the better the flavor of the smoked meat may be, and to this end, it is preferable to control the concentration of oak smoke inside the smoking chamber to 50 ppm or more. However, when the concentration is too high, the content of benzopyrene in the smoked meat may be excessive, so the upper limit thereof is limited to 300 ppm.

The concentration of oak smoke inside the smoking chamber may be measured using an optical element having a resistance value that changes according to the intensity of light and controlled by adjusting the amount of oak smoke discharged through the outlet hole.

Hereinafter, the present disclosure will be described in more detail through an example.

### Example

Smoked pork intestines were cooked using the tunnel-type automatic grilling device shown in FIG. 1. The temperature of the heating unit and the retention time were controlled as shown in Table 1 below, the temperature and concentration of carbon dioxide inside the burning chamber in which the oak firewood was burned were constantly maintained at 380° C. and 45%, respectively, and the concentration of oak smoke inside the smoking chamber was constantly maintained at 150 ppm.

TABLE 1

| Temperature of | | |
|---|---|---|
| heating unit | Retention time | |
| (° C.) | (minutes) | Remarks |
| 170 | 30 | Invention example 1 |
| 170 | 90 | Comparative Example 1 |
| 120 | 60 | Comparative Example 2 |
| 250 | 30 | Comparative Example 3 |

Then, the content of benzopyrene in the smoked pork intestines was measured using high performance liquid chromatography (HPLC), and the results are shown in Table 2 below.

TABLE 2

| Content of benzopyrene (μg/kg) | Remarks |
|---|---|
| 0.09 | Invention example 1 |
| 0.33 | Comparative Example 1 |
| 1.57 | Comparative Example 2 |
| 0.94 | Comparative Example 3 |

From Table 2, it can be confirmed that the content of benzopyrene of the produced smoked meat is significantly reduced when the temperature of the heating unit and the retention time are appropriately controlled.

There is an advantage that smoked meat produced according to one aspect of the present invention has a significantly low content of benzopyrene.

It should be understood that the effects of one aspect of the present invention are not limited to the above-described effect and include all effects inferable from the configuration described in the detailed description or claims of the invention of the present specification.

Although exemplary embodiments of the present invention has been described above, the scope of the present invention is not limited to these specific embodiments, and those skilled in the art who understand the spirit of the present invention can easily propose other embodiments by the addition, change, deletion, addition, or the like of components within the obvious scope, but it should be construed that this also pertains to the scope of the claims of the present invention.

The scope of the present specification is defined by the claims to be described below, and all changes or modifications derived from the meaning and scope of the claims and equivalent concepts thereof should be construed as being included in the scope of the present invention.

1. A method of producing smoked meat using a tunnel-type automatic grilling device, wherein the tunnel-type automatic grilling device includes:
a frame formed so that various members are mounted thereon and having an open center;
a transporting unit formed in an open area of the frame and configured to transport meat from one side to the other side of the frame by external power;
a smoking unit formed at one side of the frame and configured to supply smoke to the meat transported by the transporting unit to improve flavor;
a plurality of burner units formed below the frame at predetermined intervals and configured to apply radiant heat to a lower portion of the meat transported by the transporting unit, the radiant heat being radiated from an elvan stone heated by burning of oak firewood inserted into the burner unit;
a plurality of heating units formed at predetermined intervals at locations corresponding to the burner units above the frame and configured to apply heat to an upper portion of the meat transported by the transporting unit; and
exhaust units formed between the smoking unit and the heating units and between the plurality of heating units and configured to suction smoke generated by burning the oak firewood and then supplying the suctioned smoke to the smoking unit,
a temperature of the heating unit ranges from 150 to 200° C., and
a retention time for which the meat transported by the transporting unit retains between the burner unit and the heating unit ranges from 10 to 60 minutes.

2. The method of claim 1, wherein the oak firewood is burned inside a burning chamber, and an internal temperature of the burning chamber ranges from 250 to 500° C.

3. The method of claim 2, wherein a concentration of carbon oxide inside the burning chamber ranges from 25 to 60%.

4. The method of claim 1, wherein the smoking unit includes:
a smoking chamber formed above the frame and having one side formed with an inlet hole to which oak smoke is supplied and the other side formed with an outlet hole to which the oak smoke is discharged to smoke the meat so that oak scent is applied to the meat transported by the transporting unit; and
a sealed chamber formed below the frame to prevent the oak smoke from leaking downward from the frame or introduction of outside air.

5. The method of claim 4, wherein a concentration of the oak smoke inside the smoking chamber ranges from 50 to 300 ppm.

6. The method of claim 1, wherein the exhaust unit further includes an introduction prevention wing for preventing outside air from being introduced from a gap between the exhaust unit and the smoking unit or the heating unit.

7. The method of claim 1, wherein the burner unit includes:
a burning chamber of which upper side is open and the inside is empty;
a burning device formed at an inner central portion of the burning chamber to ignite a fire using gas supplied from the outside;
a firewood box formed on the burning device and formed so that firewood is inserted and placed inside the burning chamber;
a stand formed on the firewood box and on which an elvan stone that prevents a flame of the firewood from coming into direct contact with the meat is placed; and
a collection box formed below the burning device and configured to collect ash generated by the burning of the firewood.
